(19) United States
(12) Patent Application Publication
(10) Pub. No.: US 2009/0241165 A1
(43) Pub. Date: Sep. 24, 2009

(54) COMPLIANCE POLICY MANAGEMENT SYSTEMS AND METHODS

(75) Inventors: David S. Tyree, Centreville, VA (US); James E. Tomlinson, Falls Church, VA (US)

Correspondence Address: VERIZON;PATENT MANAGEMENT GROUP, 1320 North Court House Road, 9th Floor, ARLINGTON, VA, 22201-2909, US

(73) Assignee: VERIZON BUSINESS NETWORK SERVICE, INC., Ashburn, VA (US)

(21) Appl. No.: 12/051,474

(22) Filed: Mar. 19, 2008

(51) Int. Cl. G06F 21/00

(52) U.S. Cl. 726/1

(57) ABSTRACT

In an exemplary system, a compliance policy processing subsystem is selectively and communicatively coupled to a rules management subsystem. The rules management subsystem is configured to maintain a rules database. The compliance policy processing subsystem is configured to facilitate selection by a user of a section of text within a compliance policy, direct the rules management subsystem to identify one or more rules within the rules database that are relevant to the section of text, and display a representation of the relevant rules.

### BACKGROUND INFORMATION

Business organizations operate in a complex regulatory environment. Many organizations must comply with various federal, state, local, and international compliance policies and regulations. For example, most public corporations must comply with the Sarbanes-Oxley Act of 2002 and many other compliance policies and regulations.

In recent years, business organizations have experienced heightened regulatory scrutiny. This, in turn, has given rise to a constant barrage of additional compliance policies and regulations with which business organizations must apply.

The challenge of maintaining compliance with the ever-increasing number of policies and regulations has strained even the most robust business organizations. It has become increasingly difficult for company personnel to know and comply with the relevant policies and regulations. Moreover, the financial cost of ensuring regulatory compliance has increased dramatically in recent years.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary organizational structure of a business organization according to an exemplary embodiment.

FIG. 2 shows that one or more compliance policies may be associated with each business unit within the organization of FIG. 1 and/or the organization as a whole according to an exemplary embodiment.

FIG. 3 shows how sections of text within a plurality of compliance policies may be mapped to a common set of rules according to an exemplary embodiment.

FIG. 4 illustrates an exemplary compliance policy management system according to an exemplary embodiment.

FIG. 5 illustrates an exemplary compliance policy processing subsystem according to an exemplary embodiment.

FIG. 6 illustrates an exemplary rules management subsystem according to an exemplary embodiment.

FIG. 7 illustrates an exemplary graphical user interface (“GUI”) that may be provided by rules management subsystem to a display for presentation to one or more users in order to facilitate management of a rules database according to an exemplary embodiment.

FIG. 8 illustrates a GUI that may be presented to the user after a particular rule is selected from the GUI of FIG. 7 according to an exemplary embodiment.

FIG. 9 illustrates an exemplary pop-up window that may be displayed within the GUI of FIG. 7 when the name of a compliance policy associated with a particular rule is selected according to an exemplary embodiment.

FIG. 10 illustrates an exemplary GUI configured to facilitate viewing and selecting of one or more sections of text within a compliance policy according to an exemplary embodiment.

FIG. 11 shows the GUI of FIG. 10 after a particular section of text within the compliance policy displayed therein has been selected according to an exemplary embodiment.

FIG. 12 illustrates an exemplary method of associating a section of text within a compliance policy document with one or more rules within a rules database according to an exemplary embodiment.

FIG. 13 illustrates an exemplary method of identifying one or more rules that are relevant to a selected section of compliance policy text according to an exemplary embodiment.

### DETAILED DESCRIPTION OF PREFERRED EMBODIMENTS

Exemplary compliance policy management systems and methods are described herein. The systems and methods described herein may provide for efficient and accurate compliance with multiple compliance policies that may be associated with a business organization.

As used herein, the term “compliance policy” or simply “policy” will refer to any compliance policy, regulation, industry standard, law, or set of rules or controls corresponding to a particular industry, business unit, and/or organization. Exemplary compliance policies include, but are not limited to, the Sarbanes-Oxley Act of 2002 (“SOX”), the Payment Card Industry Data Security Standard (“PCI DSS”), the Health Insurance Portability and Accountability Act (“HIPAA”), and the Gramm-Leach-Bliley Act (“GLBA”). It will be recognized that these compliance policies are merely illustrative of the many compliance policies already in existence and yet to be developed.

In an exemplary system, a compliance policy processing subsystem is selectively and communicatively coupled to a rules management subsystem. The rules management subsystem is configured to maintain a rules database. The rules database includes one or more rules that have been derived from one or more compliance policies associated with a business organization. One or more of these rules may be common to multiple compliance policies associated with the business organization. Hence, the rules database may also include a listing of compliance policies and/or sections within compliance policies that are associated with each rule contained therein.

In some examples, the compliance policy processing subsystem is configured to facilitate selection by a user of a section of text within a compliance policy and direct the rules management subsystem to identify one or more rules within the rules database that are relevant to the selected section of text. As used herein, a rule that is “relevant” to a selected section of compliance policy text is one that has been deemed related in some way to the selected section of compliance policy text by a predefined heuristic. For example, a rule that is relevant to a selected section of compliance policy text may include at least one keyword in common with the selected section of compliance policy text.

The compliance policy processing subsystem may then display a representation of the relevant rules. In this manner, the user may analyze rules already within the rules database that are relevant to the selected section of compliance policy text, associate one or more of the relevant rules to the selected section of compliance policy text, and/or create one or more new rules within the rules database based on the selected section of compliance policy text.

Hence, the systems and methods described herein may enable personnel within an organization to more efficiently and accurately create a common set of rules covering each of the compliance polices with which the organization must comply. In this manner, compliance with a potentially large number of compliance policies may be more effectively realized. In some examples, a party external to an organization may use the systems and methods described herein to provide a service wherein the external party manages the organization's compliance with one or more compliance policies.

Exemplary implementations of compliance policy management systems and methods will now be described in more detail with reference to the accompanying drawings.

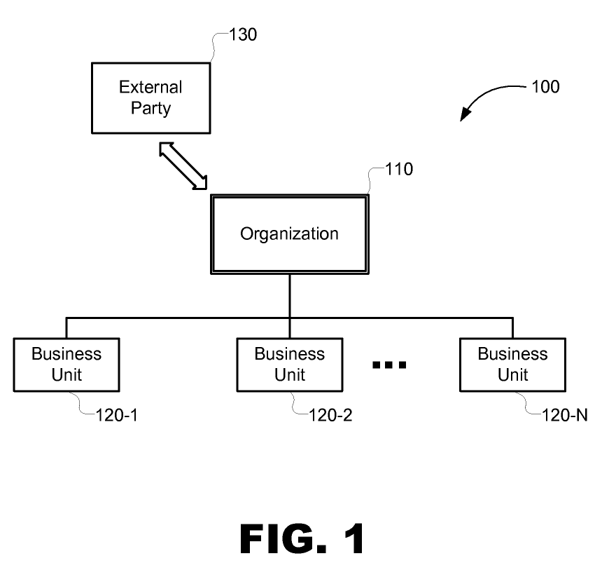

FIG. 1 illustrates an exemplary organizational structure 100 of a business organization 110. As shown in FIG. 1, a business organization 110 (or simply “organization 110”) may include a plurality of business units 120-1 through 120-N (collectively “business units 120”).

An exemplary organization 110 may include, but is not limited to, one or more corporations, enterprises, partnerships, business organizations, regional areas, reporting chains, business vendors or any other organized group or combination thereof. Organization 110 may include various managers, capital planners, and/or other personnel to manage, operate, and oversee operations of business units 120.

Business units 120 may include, but are not limited to, various divisions, departments, entities, subsidiaries, and/or other sub-groups of organization 110. For example, one or more of the business units 120 may include a particular product division or subsidiary, customer billing department, sales department, accounting department, marketing department, inventory department, ordering department, repairs department, procurement department, and/or research and development teams. Each business unit 120 may also include one or more managers, capital planners, employees, and/or other personnel to manage and operate various projects or other undertakings at the business unit level.

The number of business units 120 within organization 110 may vary as may serve a particular application. To illustrate, a large organization 110 may include ten or more business units 120.

As shown in FIG. 1, an external party 130 may interact with organization 110. As used herein, “external party” may refer to any person or organization that is external of (i.e., not part of) organization 110. Organization 110 may be customer, for example, of external party 130.

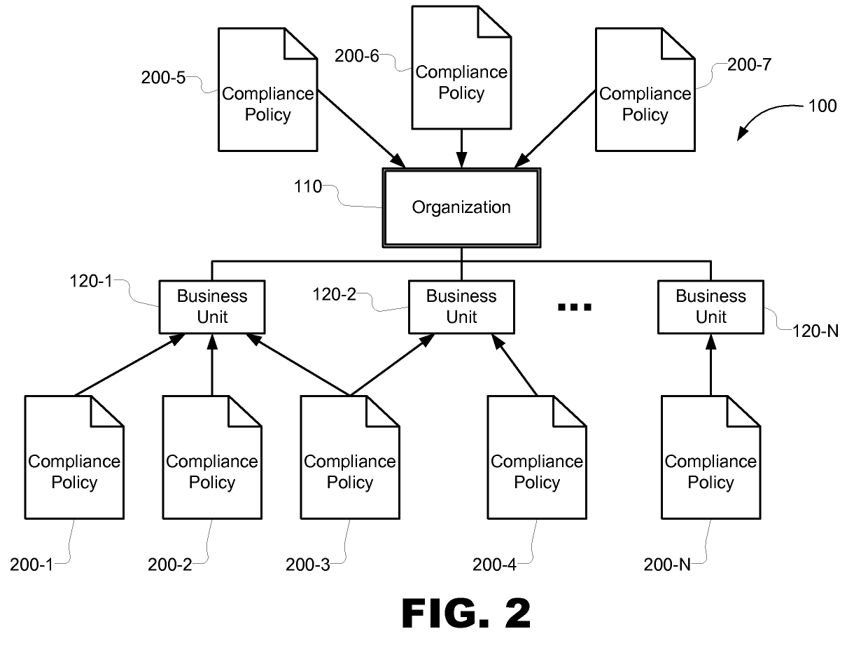

FIG. 2 shows that one or more compliance policies (e.g., 200-1 through 200-N, collectively referred to as 200) may be associated with each business unit 120 and/or the organization 110 as a whole. As used herein, if a particular compliance policy 200 is “associated” with a business unit 120 and/or an organization 110, that business unit 120 and/or organization 110 may be required to comply with the compliance policy 200. Alternatively, it may be recommended or desirable for the business unit 120 and/or organization 110 to comply with the compliance policy 200.

As mentioned, exemplary compliance policies that may be associated with a business organization include SOX, PCS DSS, HIPAA, and GLBA. It will be recognized many additional or alternative compliance policies may apply to a particular business organization. It will also be recognized that a business organization may additionally or alternatively have its own set of customized policies. For example, one or more of the policies 200 shown in FIG. 2 may be a customized internal policy applicable to organization 110 and/or one or more of the business units 120.

As shown in FIG. 2, it may be desirable for each business unit 120 to comply with different compliance policies 200. For example, business unit 120-1 may be required to comply with policies 200-1 through 200-3. In some examples, multiple business units (e.g., business units 120-1 and 120-2) may be required to comply with the same policy (e.g., policy 200-3).

In some examples, organization 110 as a whole may additionally or alternatively be required to comply with one or more compliance policies 200. For example, organization 110 shown in FIG. 2 is associated with compliance policies 200-5 through 200-7.

As mentioned, the number of compliance policies with which many organizations are to comply can be significant. It is not unusual for an organization to have to comply with tens or even hundreds of compliance policies.

Moreover, many compliance policies are long, convoluted, and complex. Hence, an organization typically employs or contracts with one or more compliance personnel who analyze the policies associated with the organization and distill each of the policies into a number of rules (also referred to as “controls”), that when complied with, ensure compliance with each of the policies.

These rules are often machine actionable. In other words, the rules may be implemented into one or more computer programs in order to facilitate more efficient and accurate compliance therewith. An organization may then ensure compliance with a plurality of compliance policies by operating within the rules derived from the policies.

In many instances, many of the compliance policies 200 with which an organization is to comply contain significant overlap. For example, a first compliance policy (e.g., 200-1) and a second compliance policy (e.g., 200-2) may both include content related to the same subject matter.

To illustrate, a first compliance policy (e.g., HIPAA) may discuss physical building security at a high level, while a second compliance policy (e.g., SOX) may discuss physical building security at a low level. Hence, compliance personnel may generate one or more common rules that satisfy the requirements of both policies. In this manner, the number of rules with which an organization must comply may be greatly reduced.

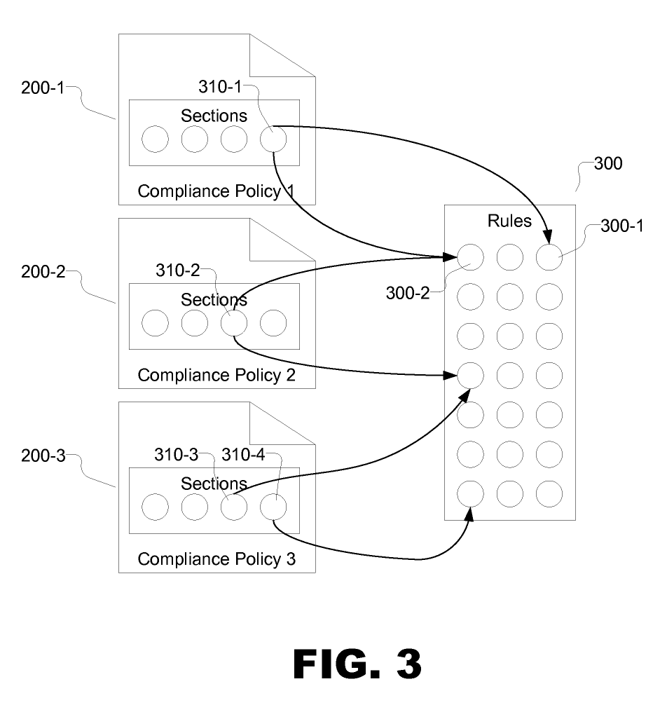

FIG. 3 graphically shows how sections of text within a plurality of compliance policies 200-1 through 200-3 may be mapped to a common set of rules 300. Three compliance policies 200 are shown in FIG. 3 for illustrative purposes only. It will be recognized that a common set of rules 300 may be derived from any number of compliance policies 200.

As shown in FIG. 3, each compliance policy 200 includes a number of sections (e.g., sections 310-1 through 310-4, collectively referred to as sections 310). As used herein, a “section” of a compliance policy 200 refers to a user-definable portion of the compliance policy 200. For example, a section may include a particular sentence, paragraph, group of words, or any other portion of text within the compliance policy 200. In some examples, a section of compliance policy text may represent a particular regulatory requirement contained within the compliance policy 200.

In some examples, one or more rules 300 may be derived from each section 310 of the compliance policies 200. For example, rules 300-1 and 300-2 may be derived from section 310-1 of compliance policy 200-1. In the example of FIG. 3, rule 300-2 also covers the content of section 310-2 of compliance policy 200-2. Hence, section 310-2 may also be mapped rule 300-2. FIG. 3 also shows the relationships between various other sections 310 (e.g., sections 310-2 through 310-4) within compliance policies 200-2 and 200-3 and the rules within common set of rules 300.

However, the process of finding, creating, and managing a set of common rules across a plurality of compliance policies is difficult, cumbersome, and error-prone due to the large number of rules that are typically included within the rule set. The process is made more difficult by the fact that new compliance policies are often added and existing compliance policies are often updated and/or otherwise modified.

To this end, the systems and methods described herein provide more efficient, flexible, and accurate compliance policy management within an organization 110.

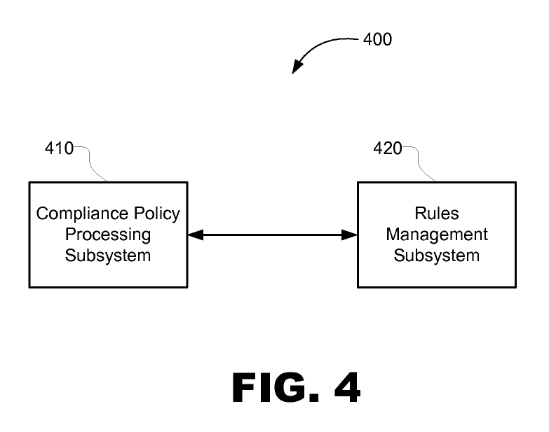

FIG. 4 illustrates an exemplary compliance policy management system 400. As shown in FIG. 4, compliance policy management system 400 (or simply “system 400”) may include a compliance policy processing subsystem 410 selectively and communicatively coupled to a rules management subsystem 420.

Compliance policy processing subsystem 410 and rules management subsystem 420 may communicate using any communication platforms and technologies suitable for transporting data, including known communication technologies, devices, media, and protocols supportive of data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Short Message Service (“SMS”), Multimedia Message Service (“MMS”), socket connections, signaling system seven (“SS7”), Ethernet, in-band and out-of-band signaling technologies, and other suitable communications networks and technologies.

In some examples, compliance policy processing subsystem 410 and rules management subsystem 420 may communicate via one or more networks, including, but not limited to, wireless networks, broadband networks, closed media networks, cable networks, satellite networks, the Internet, intranets, local area networks, public networks, private networks, optical fiber networks, and/or any other networks capable of carrying data and communications signals between compliance policy processing subsystem 410 and rules management subsystem 420.

In some examples, one or more components of system 400 may include any computer hardware and/or instructions (e.g., software programs including, but not limited to word processing software (e.g., Microsoft Word, Notepad, text viewers, PDF viewers, etc.), database software (e.g., Microsoft Access, SQL, etc.), spreadsheet software (e.g., Microsoft Excel, etc.), search engines, and/or programming software) or combinations of software and hardware, configured to perform the processes described herein. In particular, it should be understood that one or more components of system 400 may be implemented on one physical computing device or may be implemented on more than one physical computing device. For example, compliance policy processing subsystem 410 and rules management subsystem 420 may be implemented on one physical computing device or on more than one physical computing device. Accordingly, system 400 may include any one of a number of computing devices, and may employ any of a number of computer operating systems, including, but by no means limited to, versions and/or varieties of the Microsoft Windows, UNIX, Macintosh, and Linux operating systems.

Accordingly, one or more processes described herein may be implemented at least in part as computer-executable instructions, i.e., instructions executable by one or more computing devices, tangibly embodied in a computer-readable medium. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

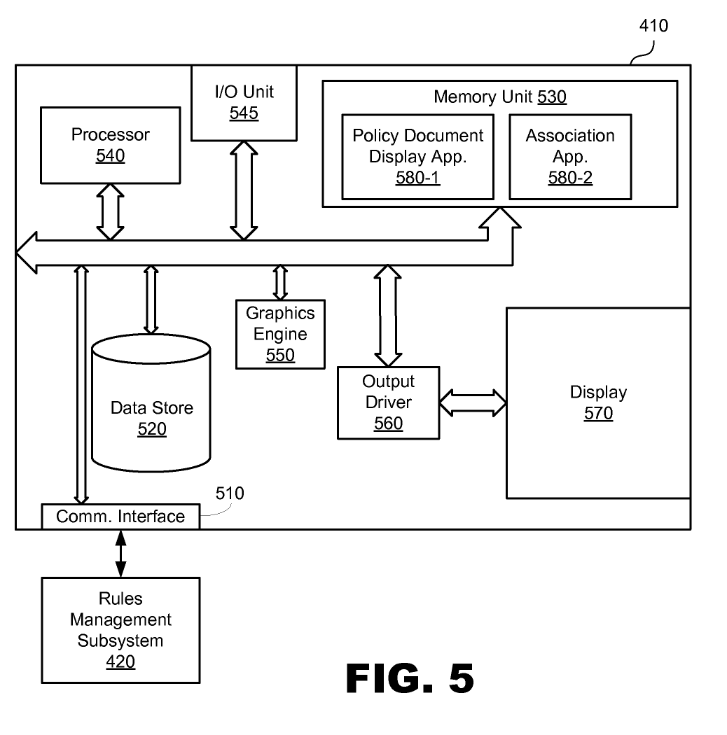

FIG. 5 illustrates an exemplary compliance policy processing subsystem 410. Compliance policy processing subsystem 410 may be configured to interact with various peripherals such as a terminal, keyboard, mouse, display screen, printer, stylus, input device, output device, or any other apparatus.

As will be described in more detail below, compliance policy processing subsystem 410 is configured to process data representative of one or more compliance policies. For example, compliance policy processing subsystem 410 may be configured to process compliance policy data (e.g., a compliance policy file) to display the text of a compliance policy, allow selection of one or more sections of the policy, and facilitate or provide for association of the selected sections with one or more rules, including one or more rules associated with multiple compliance policies.

As shown in FIG. 5, compliance policy processing subsystem 410 may include a communication interface 510, data store 520, memory unit 530, processor 540, input/output unit 545 (“I/O unit 545”), graphics engine 550, output driver 560, and display 570 communicatively connected to one another. While an exemplary compliance policy processing subsystem 410 is shown in FIG. 5, the exemplary components illustrated in FIG. 5 are not intended to be limiting. Indeed, additional or alternative components and/or implementations may be included within the compliance policy processing subsystem 410.

Communication interface 510 may be configured to send and receive data to/from rules management subsystem 420. Communication interface 510 may include any device, logic, and/or other technologies suitable for transmitting and receiving data. The communication interface 510 may be configured to interface with any suitable communication media, protocols, formats, platforms, and networks, including any of those mentioned herein.

Data store 520 may include one or more data storage media, devices, or configurations and may employ any type, form, and combination of storage media. For example, the data store 520 may include, but is not limited to, a hard drive, network drive, flash drive, magnetic disc, optical disc, or other non-volatile storage unit. Data, including data representative of one or more compliance policies, may be temporarily and/or permanently stored in the data store 520.

Memory unit 530 may include, but is not limited to, FLASH memory, random access memory (“RAM”), dynamic RAM (“DRAM”), or a combination thereof. In some examples, as will be described in more detail below, applications executed by compliance policy processing subsystem 410 may reside in memory unit 530.

Processor 540 may be configured to control operations of components of the compliance policy processing subsystem 410. Processor 540 may direct execution of operations in accordance with computer-executable instructions such as may be stored in memory unit 530. As an example, processor 540 may be configured to process data representative of one or more sections of a compliance policy, including identifying one or more keywords within the one or more sections of the compliance policy.

I/O unit 545 may be configured to receive user input and provide user output and may include any hardware, firmware, software, or combination thereof supportive of input and output capabilities. For example, I/O unit 545 may include one or more devices for inputting and/or receiving data and/or commands and may include, but is not limited to, a keyboard or keypad, a touch screen component, a mouse or other pointer device, a device driver, etc.

As instructed by processor 540, graphics engine 550 may generate graphics, which may include word processing windows or other graphics, tables, reports, charts, graphical spreadsheets, and/or any other graphical user interface (“GUI”). The output driver 560 may provide output signals representative of the graphics generated by graphics engine 550 to display 570. The display 570 may then present the graphics for experiencing by a user.

One or more applications (e.g., 580-1 and 580-2, collectively referred to as applications 580) may be executed by the compliance policy processing subsystem 410. The applications 580, or application clients, may reside in memory unit 530 or in any other area of the compliance policy processing subsystem 410 and may be executed by processor 540. Each application 580 may correspond to a particular set of one or more features or capabilities of the compliance policy processing subsystem 410. For example, illustrative applications 580 may include a policy document display application 580-1 configured to facilitate display of one or more compliance policy documents and an association application 580-2 configured to facilitate association of a particular compliance policy section with one or more rules. Additional or alternative applications 580 may be included within compliance policy processing subsystem 410 as may serve a particular application.

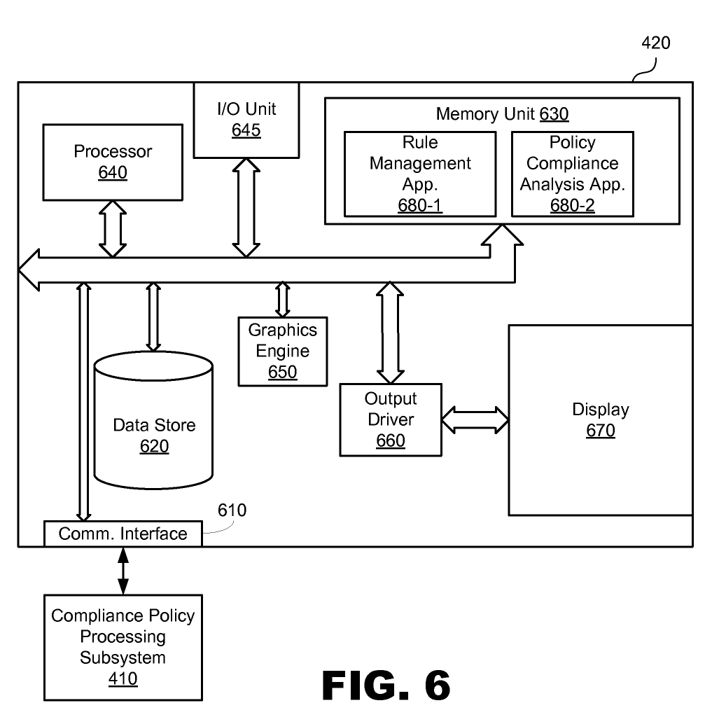

FIG. 6 illustrates an exemplary rules management subsystem 420. As will be described in more detail below, rules management subsystem 420 is configured to facilitate or provide for creation, modification, association, and/or management of one or more rules corresponding to a set of compliance policies. Rules management subsystem 420 may be configured to interact with various peripherals such as a terminal, keyboard, mouse, display screen, printer, stylus, input device, output device, or any other apparatus.

As shown in FIG. 6, rules management subsystem 420 may include a communication interface 610, data store 620, memory unit 630, processor 640, input/output unit 645 (“I/O unit 645”), graphics engine 650, output driver 660, and display 670 communicatively connected to one another. While an exemplary rules management subsystem 420 is shown in FIG. 6, the exemplary components illustrated in FIG. 6 are not intended to be limiting. Indeed, additional or alternative components and/or implementations may be included within the rules management subsystem 420.

Communication interface 610 may be configured to send and receive data to/from compliance policy processing subsystem 410. Communication interface 610 may include any device, logic, and/or other technologies suitable for transmitting and receiving data. The communication interface 610 may be configured to interface with any suitable communication media, protocols, formats, platforms, and networks, including any of those mentioned herein.

Data store 620 may include one or more data storage media, devices, or configurations and may employ any type, form, and combination of storage media. For example, the data store 620 may include, but is not limited to, a hard drive, network drive, flash drive, magnetic disc, optical disc, or other non-volatile storage unit. Data, including data representative of one or more rules, compliance policies, and/or sections thereof, may be temporarily and/or permanently stored in data store 620.

Memory unit 630 may include, but is not limited to, FLASH memory, RAM, DRAM, or a combination thereof. In some examples, as will be described in more detail below, applications executed by the rules management subsystem 420 may reside in memory unit 630.

Processor 640 may be configured to control operations of components of the rules management subsystem 420. Processor 640 may direct execution of operations in accordance with computer-executable instructions such as may be stored in memory unit 630. As an example, processor 640 may be configured to process data communicated to the rules management subsystem 420 from the compliance policy processing subsystem 410.

I/O unit 645 may be configured to receive user input and provide user output and may include any hardware, firmware, software, or combination thereof supportive of input and output capabilities. For example, I/O unit 645 may include one or more devices for inputting and/or receiving project data and may include, but is not limited to, a keyboard or keypad, a touch screen component, a mouse or other pointer device, a device driver, etc.

As instructed by processor 640, graphics engine 650 may generate graphics, which may include database graphics, word processing graphics, tables, reports, charts, graphical spreadsheets, and/or any other graphical user interface (“GUI”). The output driver 660 may provide output signals representative of the graphics generated by graphics engine 650 to display 670. The display 670 may then present the graphics for experiencing by a user.

One or more applications (e.g., 680-1 and 680-2, collectively referred to herein as 680) may be executed by the rules management subsystem 420. The applications 680, or application clients, may reside in memory unit 630 or in any other area of the rules management subsystem 420 and may be executed by processor 640. Each application 680 may correspond to a particular set of one or more features or capabilities of the rules management subsystem 420. For example, an illustrative application 680 may include a rule management application 680-1 configured to facilitate creation, modification, association, and/or management of one or more rules corresponding to a set of compliance policies. Another illustrative application 680 may include a policy compliance analysis application 680-2 configured to facilitate analysis of an organization's level of compliance with one or more compliance policies. Additional or alternative applications 680 may be included within rules management subsystem 420 as may serve a particular application.

In some examples, rules management subsystem 420 is configured to maintain a database or library of rules derived from a set of compliance policies associated with an organization. As will be described in more detail below, the rules database may include a listing of each rule within the rules database, a listing of the compliance policies associated or linked with each rule, text of the relevant sections within the compliance policies associated with each rule, and/or a listing of one or more keywords associated with each rule.

Exemplary database applications that may be used to manage the rules database include, but are not limited to, Microsoft Access, SQL, and/or any other suitable application as may serve a particular application. In some examples, the rules database may be stored within data store 620, a data store located external to rules management subsystem 420, and/or within any other storage media as may serve a particular application.

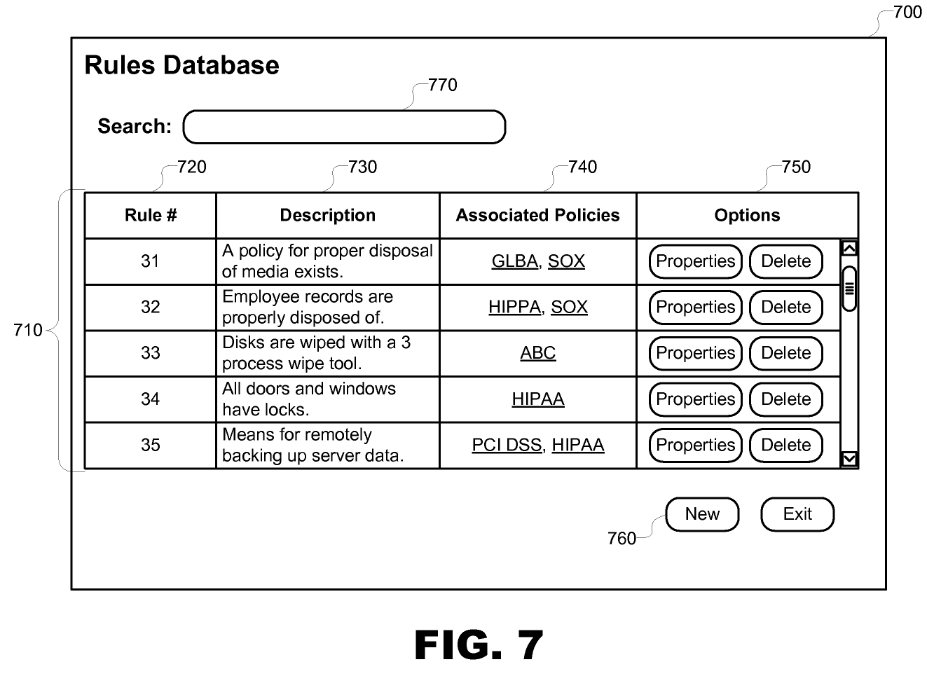

FIG. 7 illustrates an exemplary GUI 700 that may be provided by rules management subsystem 420 to a display for presentation to one or more users in order to facilitate management of the rules database. The one or more users may be a part of organization 110, external party 130, and/or any other organization as may serve a particular application.

GUI 700 and other GUIs described herein may be presented or displayed via display 670 or any other display as may serve a particular application. Moreover, the GUIs shown and described herein may be presented within a web browser, custom software program, or any other suitable application as may serve a particular application. In this manner, simultaneous access and editing by multiple users may be facilitated. It will be recognized that the GUIs shown and described herein are merely illustrative of the many different types and forms of GUIs that may be used in connection with the systems and methods described herein.

As shown in FIG. 7, GUI 700 is configured to present a summary 710 of the contents of the rules database. Summary 710 may include a listing 720 of the rule numbers of other identifiers, a description 730 of each rule, a listing 740 of the compliance policies associated with each rule, and one or more options 750 associated with each rule.

To illustrate, the GUI 700 shown in FIG. 7 shows that at least five rules (e.g., rules 31-35) are included within the rules database. It will be recognized that any number of rules may be included within the database as may serve a particular application. Rule 31, for example, states that a policy for proper disposal of media should exist. FIG. 7 shows that two compliance policies (i.e., GLBA and SOX) are currently associated with rule 31. It will be recognized that the compliance policies listed within GUI 700 are merely illustrative of the many different policies that may be associated with each rule within the rules database as may serve a particular application.

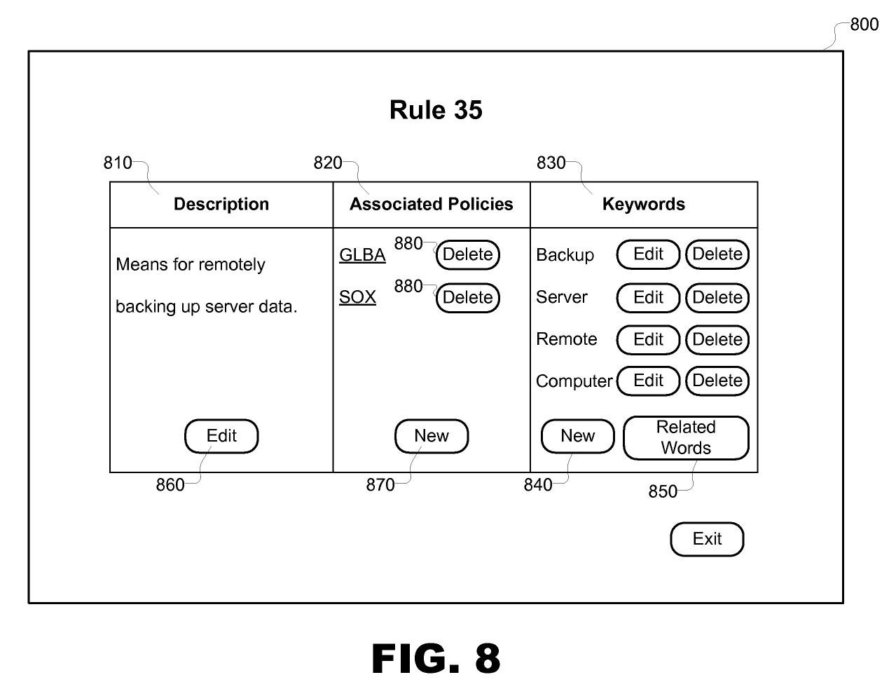

In some examples, a user may select a particular rule to view and/or edit one or more properties associated therewith. For example, FIG. 8 illustrates a GUI 800 that may be presented to the user after a particular rule (e.g., rule 35) is selected from GUI 700. As shown in FIG. 8, a number of properties associated with the selected rule are shown. For example, GUI 800 shows a description 810 of the selected rule, the compliance policies 820 associated with the selected rule, and a number of keywords 830 associated with the selected rule.

The keywords 830 may be used to facilitate more accurate and effective searching within the rules. For example, the keywords listed in GUI 800 are related to the subject matter of rule 35 (i.e., a means for remotely backing up server data). As will be described in more detail below, the keywords enable a user to more easily locate a rule and/or associate a rule with a particular section of a compliance policy.

In some examples, one or more of the keywords may be entered into the rules database by a user. For example, a user may select a “new” link 840 to enter one or more new keywords into the list of keywords associated with the selected rule. Additionally or alternatively, one or more of the keywords may be automatically generated by the rules management subsystem 420.

In some examples, a “related words” link 850 may additionally or alternatively be provided that, when selected, allows a user to associate one or more related words to one of the keywords. For example, if one of the keywords is “building,” a user may enter words such as “facility,” “lobby,” “loading dock,” and the like as words related to the word “building.” These related words may also facilitate more effective searching of the rules and/or association of a policy section to one or more of the rules within the rules database. The related words may be stored within the rules database.

GUI 800 may additionally or alternatively allow a user to edit the description of the selected rule. For example, a user may select an “edit” link 860 to edit the description of rule 35. In some examples, rules management subsystem 420 may be configured to track changes made to a rule within the rules database.

GUI 800 may additionally or alternatively allow a user to associate and/or disassociate compliance policies and/or sections of compliance policies with a rule. For example, a user may select a “new” link 870 to associate a new compliance policy with rule 35. Likewise, a user may select one of the “delete” links 880 to disassociate one or more of the compliance policies that have already been associated with rule 35.

Returning to FIG. 7, a user may select one of the compliance policies listed within the associated policies column 740 in order to access more detailed information about the selected compliance policy. To this end, one or more hyperlinks (represented in FIG. 7 by underlined text) may be associated with the names of the compliance policies listed within the associated policies column 740. Additional or alternative means may be used to facilitate selection of the compliance policies as may serve a particular application.

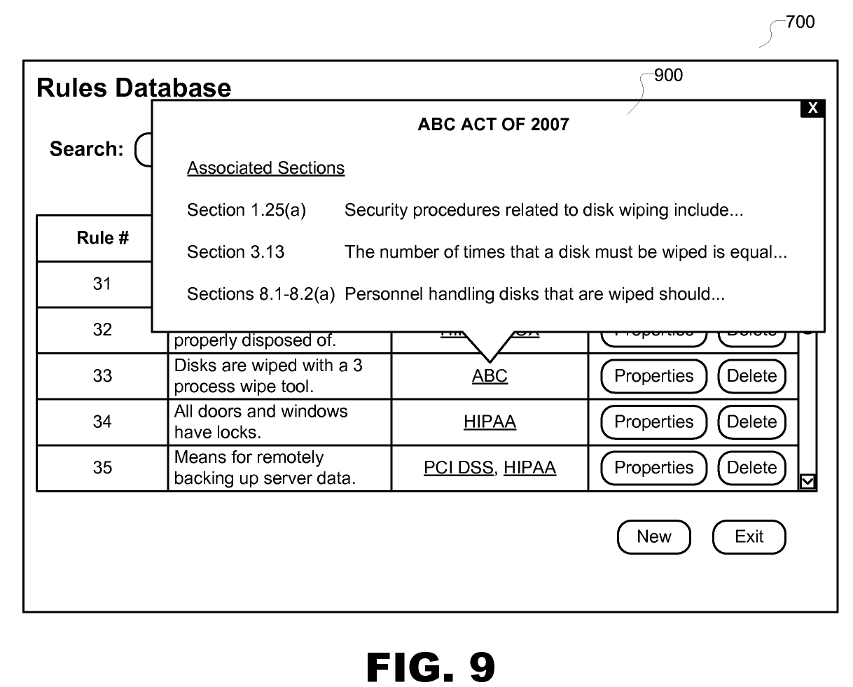

FIG. 9 illustrates an exemplary pop-up window 900 that may be displayed within GUI 700 when the name of a compliance policy associated with a particular rule is selected. As shown in FIG. 9, a policy named “ABC” that is associated with rule 33 has been selected. While a pop-up window 900 is shown in FIG. 9, it will be recognized that another GUI or other graphic may additionally or alternatively be displayed in response to a compliance policy being selected as may serve a particular application.

As shown in FIG. 9, pop-up window 900 may include various details corresponding to the selected compliance policy. For example, pop-up window 900 may include a listing of sections within the selected compliance policy that have been associated with the corresponding rule. Pop-up window 900 may additionally or alternatively include text of the associated sections and/or links to one or more options related to the selected compliance policy as may serve a particular application.

Returning to FIG. 7, GUI 700 may be configured to facilitate creation of one or more new rules within the rules database. For example, a user may select a “new” link 760 to create a new rule within the rules database. A pop-up window, GUI, or other graphic may be displayed after the “new” link 760 is selected to facilitate manual entry of a description of the new rule.

Additionally or alternatively, one or more new rules may be automatically generated by rules management subsystem 420. For example, rules management subsystem 420 may be configured to automatically generate one or more rules based on one or more sections of a compliance policy.

GUI 700 may additionally or alternatively include a search field 770 configured to facilitate searching within the rules/or and associated policies included within the rules database. Rules management subsystem 420 may be configured to process a search request and generate one or more search results using any suitable procedure and/or technique as may serve a particular application.

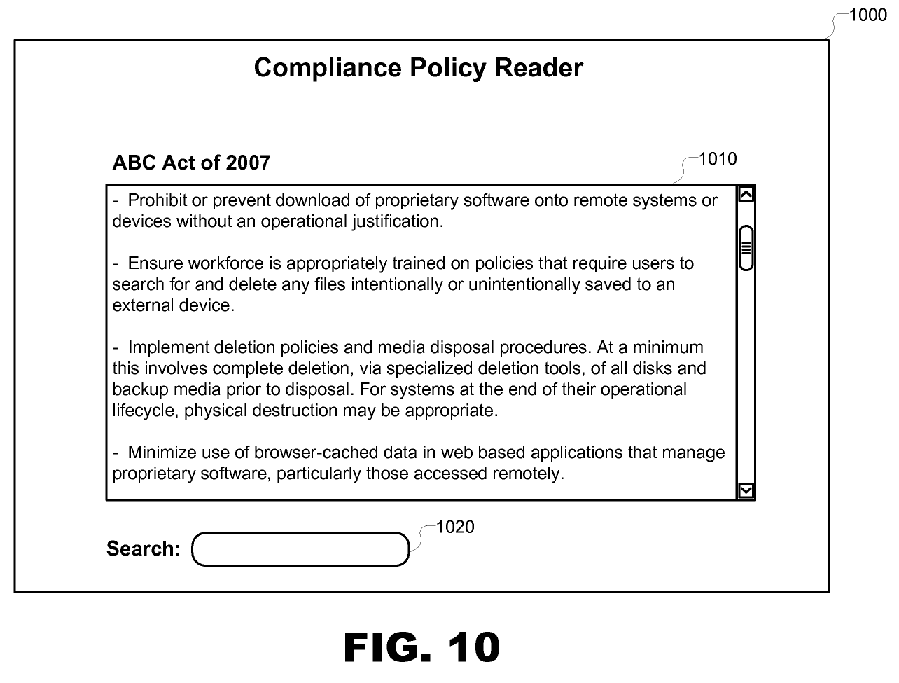

In some examples, compliance policy processing subsystem 410 may be configured to facilitate analysis of a compliance policy and association of one or more sections within the compliance policy with one or more rules within the rules database. To this end, as shown in FIG. 10, compliance policy processing subsystem 410 may be configured to provide a GUI 1000 configured to facilitate viewing and selection of one or more sections of text within a compliance policy. As will be described in more detail below, a user may use GUI 1000 to select a section of text within a compliance policy and associate the selected section with one or more rules within rules database.

As shown in FIG. 10, GUI 1000 may include a viewing window 1010 configured to display the text of one or more compliance policies. For example, the text of a compliance policy named “ABC Act of 2007” is displayed within the viewing window 1010 shown in FIG. 10. Compliance policy processing subsystem 410 may be configured to present the text of a compliance policy in any suitable format including, but not limited to, Rich Text Format (“RTF”), Portable Document Format (“PDF”), HyperText Markup Language (“HTML”), Microsoft Word format, and/or any other format as may serve a particular application.

GUI 1000 may additionally or alternatively include a search field 1020 configured to allow a user to search within the text of a compliance policy. In this manner, a user may easily locate a desired section within the compliance policy.

To view rules that are relevant to a particular section of text within a compliance policy, a user may select the section by highlighting, mousing over, and/or otherwise distinguishing the section from the rest of the text of the compliance policy.

In response to the section of text being selected, compliance policy processing subsystem 410 may be configured to analyze the words contained within the selected section of text, communicate with rules management subsystem 420 to determine which rules within the rules database are relevant to the content of the selected section, and display a representation of one or more rules that are determined to be relevant to the selected section of the content policy.

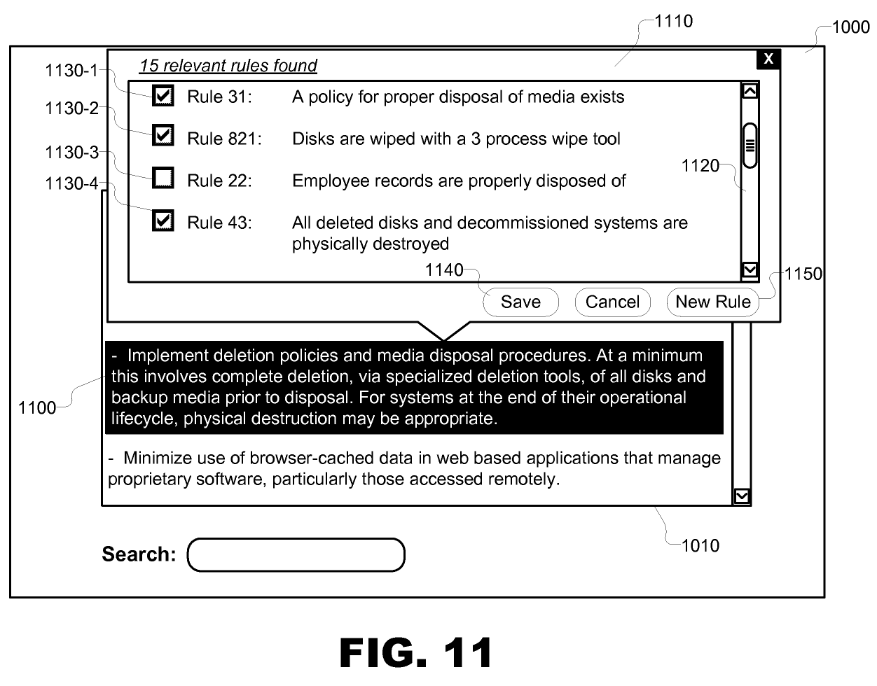

To illustrate, FIG. 11 shows the GUI 1000 of FIG. 10 after a particular section 1100 of text within the compliance policy shown in viewing window 1010 has been selected. In the example of FIG. 11, the selected section 1100 has been highlighted. However, it will be recognized that section 1100 may be selected using any other method as may serve a particular application.

Once the section 1100 has been selected, compliance policy processing subsystem 410 may process and/or analyze the words contained within the selected selection 1100 and communicate with rules management subsystem 420 to determine which rules within the rules database are relevant to the content of the selected section. For example, the selected section 1100 may be parsed to locate one or more keywords. These keywords may then be communicated to rules management subsystem 420, which may be configured to search for the communicated keywords within the rules database. Alternatively, compliance policy processing subsystem 410 may be configured to access the rules database and search therein for the keywords found within the selected section 1100.

Compliance policy processing subsystem 410 and/or rules management subsystem 420 may then identify one or more rules within the rules database that are relevant to the selected section 1100. Such identification may be based on keyword matching or any other heuristic or process as may serve a particular application. An exemplary method of identifying one or more rules that are relevant to a selected section of text within a compliance policy will be described in more detail below.

In some examples, rules management subsystem 420 and/or compliance policy processing subsystem 410 may be configured to display a representation of the identified rules that are relevant to the selected compliance policy section 1110. For example, a pop-up window 1110 displaying a list of the relevant rules may be displayed within GUI 1000, as shown in FIG. 11. It will be recognized that the representation of relevant rules may additionally or alternatively be displayed within any other GUI or graphic as may serve a particular application.

To illustrate, pop-up window 1110 shows that fifteen rules are relevant to the selected compliance policy section 1100. To access rules not currently showing within pop-up window 1110, a user may scroll the list up or down using the scroll bar 1120 displayed within pop-up window 1110, navigational buttons that are a part of a keyboard or other input device, a scroll wheel that is a part of a mouse, and/or any other means for scrolling as may serve a particular application.

The order in which the potentially relevant rules are presented within pop-up window 1110 may be controlled by rules management subsystem 420 and/or compliance policy processing subsystem 410, or may be specified by the user. For example, the list of potentially relevant rules may be sorted by relevance (e.g., number of keyword matches, etc.), in alphabetical order, in numerical order, or any other order as may serve a particular application.

In some examples, a user may select one or more of the relevant rules displayed within pop-up window 1110 to associate those rules with the selected compliance policy section 1100. In other words, the selected rules are linked to the selected compliance policy section 1100 within the rules database. To this end, one or more checkboxes (e.g., 1130-1 through 1130-4, collectively referred to as “checkboxes 1130”) or other selection means may be provided for each rule listed within pop-up window 1110. To associate a particular rule with the selected section 1100, the user may select a checkbox 1130 corresponding to the particular rule.

To illustrate, the checkboxes 1130 shown in FIG. 11 show that three rules (i.e., rule 31, rule 821, and rule 43) have been associated with the selected section 1100 and that one rule (i.e., rule 22) has not been associated with the selected section 1100. It will be understood that the rules within pop-up window 1110 may be selected for association using any other selection method as may serve a particular application.

After the desired rules have been selected, the user may select a “save” link 1140 or the like to save the newly created rule associations within the rules database. In some alternative examples, the associations are automatically saved within the rules database as the checkboxes 1130 are checked.

In response to selection of the “save” link 1140, compliance policy processing subsystem 410 may transmit data representative of the newly created rule associations to rules management subsystem 420. Rules management subsystem 420 may then update the rules database accordingly.

In some examples, compliance policy processing subsystem 410 and/or rules management subsystem 420 may fail to identify one or more rules within the rules database that are relevant to the selected section 1100. This may be due to the fact that a rule related to the subject matter of the selected section 1100 does not yet exist within the rules database. In these instances, the user may desire to create a new rule based on the selected section 1100. Even if one or more relevant rules are identified, the user may desire to create a new rule in addition to or instead of selecting one of the relevant rules for association.

To this end, pop-up window 1110 may include a “new rule” link 1150 configured to facilitate creation of a new rule within the rules database. In response to the “new rule” link 1150 being selected, compliance policy processing subsystem 410 may be configured to display another GUI, pop-up window, or other graphic configured to facilitate creation of a new rule. Once the new rule is created, the user may optionally associate the new rule with the selected text 1100 and/or direct compliance policy processing subsystem 410 to transmit data representative of the new rule to rules management subsystem 420. Rules management subsystem 420 may then update the rules database with the new rule.

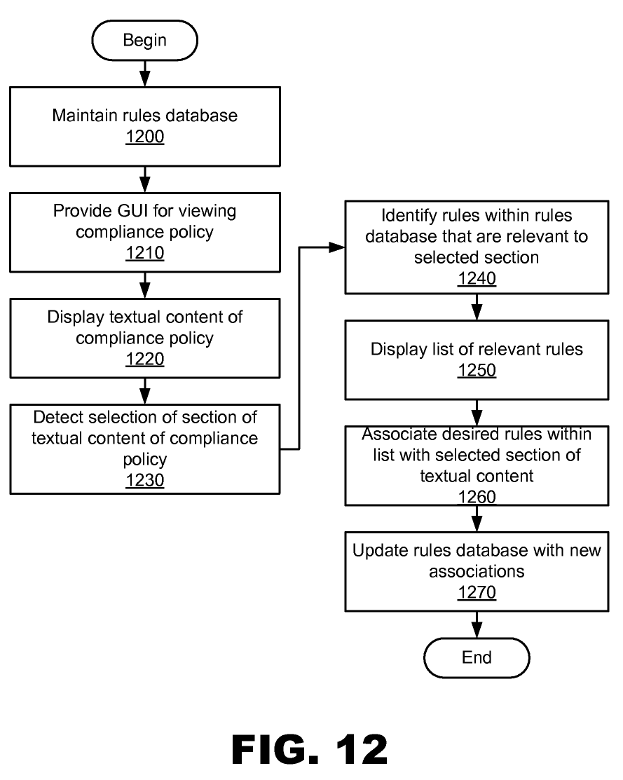

FIG. 12 illustrates an exemplary method of associating a section within a compliance policy document with one or more rules within a rules database. While FIG. 12 illustrates exemplary steps according to one implementation, other implementations may omit, add to, reorder, and/or modify any of the steps shown in FIG. 12.

In step 1200, a rules database is maintained. The rules database may be located within a rules management subsystem (e.g., rules management subsystem 420), for example. The rules database may be configured such that multiple users within an organization and/or within an external party may simultaneously access, modify, and/or update data within the rules database.

In step 1210, a GUI is provided for viewing a compliance policy. The GUI may be similar to any of the GUIs described herein. In some examples, the GUI may be configured to facilitate graphical selection of one or more sections of the compliance policy.

In step 1220, textual content of a compliance policy may be displayed within the GUI provided in step 1210. The textual content may be displayed in any of the ways described herein.

In step 1230, a selection of a section of the textual content of the compliance policy is detected. The section may be selected in any of the ways described herein.

In step 1240, one or more rules within the rules database that are relevant to the selected section are identified. Relevant rules may be identified in any of the ways described herein. In some examples, if no relevant rules are identified, an option of creating a new rule within the rules database based on the selected section may be provided.

In step 1250, a representation of the relevant rules is displayed. The list may be displayed within the GUI provided in step 1210, for example. Alternatively, the list may be displayed within any other GUI, pop-up window, or other graphic as may serve a particular application. The list may be sorted in any of the ways described herein.

In step 1260, one or more rules within the representation of relevant rules are associated with the selected section of textual content. The rules may be associated in any of the ways described herein.

In step 1270, the rules database is updated with the associations as designated in step 1260. The rules database may be updated in any of the ways described herein.

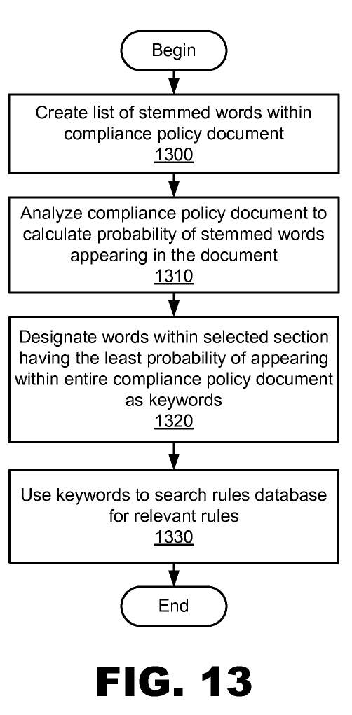

FIG. 13 illustrates an exemplary method of identifying one or more rules that are potentially relevant to a selected section of compliance policy text. While FIG. 13 illustrates exemplary steps according to one implementation, other implementations may omit, add to, reorder, and/or modify any of the steps shown in FIG. 13. Moreover, it will be recognized that the method of FIG. 13 is merely illustrative of the many different methods that may be used to identify one or more rules as being potentially relevant to a selected section of compliance policy text.

In step 1300, a compliance policy document is analyzed to determine a list of “stemmed words” within the document. As used herein, a “stemmed word” refers to the base or root form of a word. For example, the stemmed word for “deletion” may be “delete.”

In step 1310, the compliance policy document is analyzed to calculate the probability of each of the stemmed words appearing in the document.

In step 1320, one or more of the words within the selected section that have the least probability of appearing within the entire compliance policy document are designated as keywords.

In step 1330, the keywords as determined in step 1320 are used to search within the rules database for one or more relevant rules. In this manner, a listing of rules relevant to the selected section of compliance policy text may be determined and sorted in order of relevance.

While the systems and methods described herein have been illustrated as facilitating compliance with multiple compliance policies, they may additionally or alternatively be used to manage contractual obligations or any other set of rules with which an organization is to comply.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a rules management subsystem; and
a compliance policy processing subsystem selectively and communicatively coupled to said rules management subsystem;
wherein said rules management subsystem is configured to maintain a rules database; and
wherein said compliance policy processing subsystem is configured to
facilitate selection by a user of a section of text within a compliance policy,
direct said rules management subsystem to identify one or more rules within said rules database that are relevant to said section of text, and
display a representation of said relevant rules.

2. The system of claim 1, wherein said compliance policy processing subsystem is further configured to direct said rules management subsystem to associate said one or more of said relevant rules and said section of text within said rules database.

3. The system of claim 1, wherein said identification of said one or more rules that are relevant to said section of text is based on a keyword analysis of said section of text.

4. The system of claim 1, wherein said compliance policy processing subsystem is further configured to display a graphical user interface configured to present text of said compliance policy to said user.

5. The system of claim 1, wherein said rules database comprises:
a listing of a plurality of rules corresponding to a plurality of compliance policies;
a listing of one or more compliance policies associated with each of said rules; and
a listing of one or more keywords associated with each of said rules.

6. The system of claim 1, wherein said compliance policy processing subsystem is further configured to facilitate creation of one or more new rules to be included within said rules database.

7. The system of claim 1, wherein said representation of said relevant rules includes a listing of said relevant rules presented in an order of relevance to said section of text.

8. The system of claim 1, wherein said compliance policy processing subsystem is further configured to:
facilitate selection by said user of a section of text within another compliance policy;
direct said rules management subsystem to identify one or more rules within said rules database that are relevant to said section of text within said another compliance policy; and
display a representation of said rules that are relevant to said section of text within said another compliance policy.

9. The system of claim 1, wherein said rules management subsystem is further configured to display a graphical user interface configured to facilitate editing of one or more rules within said rules database.

10. The system of claim 1, wherein said rules management subsystem is further configured to display a graphical user interface configured to facilitate editing of one or more keywords associated with one or more rules within said rules database.

11. A method comprising:
maintaining a rules database including a plurality of rules;
displaying a graphical user interface, said graphical user interface including textual content included in a compliance policy;
detecting a user selection of a section of said textual content;
identifying at least one of said rules within said rules database that is relevant to said section of said textual content based on a predefined heuristic; and
displaying a graphical representation of said identified at least one of said rules.

12. The method of claim 11, further comprising:
analyzing said selected section of said textual content to identify at least one keyword included in said selected section of said textual content; and
utilizing said at least one keyword to identify said at least one of said rules as including at least one match for said at least one keyword.

13. The method of claim 12, wherein said analyzing comprises:
creating a list of stemmed words within said textual content of said compliance policy;
determining a probability of each of said stemmed words appearing within said textual content of said compliance policy; and
designating one or more words within said selected section of said contextual content as said at least one keyword based on said probability determination.

14. The method of claim 11, further comprising associating one or more of said relevant rules to said section of said textual content.

15. The method of claim 11, wherein said identifying comprises analyzing one or more keywords within said section of said textual content.

16. The method of claim 11, further comprising:
displaying within said graphical user interface textual content included within another compliance policy;
detecting a user selection of a section of said textual content within said another compliance policy;
identifying at least one of said rules within said rules database that is relevant to said section of said textual content within said another compliance policy based on said predefined heuristic; and
displaying a graphical representation of said identified at least one of said rules that is relevant to said section of said textual content within said another compliance policy.

17. The method of claim 11, further comprising facilitating editing of one or more rules within said rules database.

18. A method comprising:
managing compliance of an organization with one or more compliance policies;
maintaining a rules database including a plurality of rules corresponding to said organization;
displaying a graphical user interface, said graphical user interface including textual content included in one of said compliance policies;
detecting a user selection of a section of said textual content;
identifying at least one of said rules within said rules database that is relevant to said section of said textual content based on a predefined heuristic; and
displaying a graphical representation of said identified at least one of said rules.

19. The method of claim 18, wherein said managing is performed by a party external to said organization.

20. The method of claim 18, further comprising associating one or more of said relevant rules to said section of said textual content.

21. A computer-readable medium including instructions configured to direct a computer to:
facilitate graphical selection by a user of a section of text within a compliance policy;
identify one or more rules within a rules database that are relevant to said section of text; and
display a representation of said related rules.

22. The computer-readable medium of claim 21, wherein said instructions are further configured to direct said computer to associate one or more of said relevant rules to said section of text within said rules database.

23. The computer-readable medium of claim 21, wherein said instructions are further configured to direct said computer to identify said related rules by analyzing one or more keywords within said section of text.
